(19) United States
(12) Patent Application Publication
(10) Pub. No.: US 2019/0256188 A1
(43) Pub. Date: Aug. 22, 2019

(54) Airfoil Modification To Improve Fuel Efficiency

(71) Applicant: Aviation Partners, Inc., Seattle, WA (US)

(72) Inventor: Danny A. Sikavi, Redmond, WA (US)

(21) Appl. No.: 16/283,546

(22) Filed: Feb. 22, 2019

Related U.S. Application Data
(60) Provisional application No. 62/634,173, filed on Feb. 22, 2018.

(51) Int. Cl. B64C 3/14; B64C 21/00

(52) U.S. Cl. CPC B64C 3/14; F15D 1/10; B64C 2003/147; B64C 21/00

(57) ABSTRACT

Systems and methods for reducing or weakening the shocks acting on an airfoil, such as an airfoil of an airplane wing. In one embodiment, the length of an airfoil is increased by shifting the trailing edge aft by installing a trailing edge extender. In one embodiment, the length and shape of an airfoil is changed by shifting the trailing edge aft and downward by installing a trailing edge extender. In one embodiment, an airfoil is changed by removing a portion of the wing at the trailing edge and increasing the camber by installing a trailing edge modifier to adjust the circulation surrounding the wing and redistribute loading of the wing. Modifications of an airplane wing, including installing a trailing edge extender, are easy to implement, do not require span extensions or tip devices, and improve fuel efficiency.

### PRIORITY

This application claims the benefit of priority to U.S. Provisional Application No. 62/634,173, filed Feb. 22, 2018, which is incorporated by reference in its entirety into this application.

### BACKGROUND

The primary lifting surface of an aircraft is its wing, which has a cross-sectional shape called an airfoil. The airfoil of the wing moved through air produces an aerodynamic force. The component of this force perpendicular to the direction of motion is called lift, and parallel to the direction of motion is called drag. Subsonic flight airfoils have a characteristic shape with a rounded leading edge, followed by a sharp trailing edge, often with a symmetric curvature of upper and lower surface. Most modern transport and business jets cruise in the transonic flow regime (0.70≤MACH≤1.0). Under this type of flight condition the aircraft wing generates shocks, from its constituent airfoils on the upper lifting surfaces.

The overall drag on an airfoil, such as a wing, generally includes: 1) wave drag, 2) induced drag (due to lift), and 3) profile drag, which is a function of total wetted area of the airfoil. As will be appreciated, shocks produced by a wing generally result in entropy losses and higher wave drag. Thus, weakening the shocks acting on the wing results in decreased wave drag, which may translate into reduced overall drag and better fuel efficiency.

### SUMMARY OF THE INVENTION

Accordingly, disclosed herein are systems and methods for reducing or weakening the shocks acting on an airfoil, such as an airfoil of an airplane wing. In one embodiment, the length of an airfoil is increased by shifting the trailing edge aft. In one embodiment, the length of an airfoil is increased by shifting the trailing edge aft by installing a trailing edge extender. In one embodiment, the length and shape of an airfoil is changed by shifting the trailing edge aft and downward by installing a trailing edge extender. In one embodiment, an airfoil is changed by removing a portion of the wing at the trailing edge and increasing the camber by installing a trailing edge modifier to adjust the circulation surrounding the wing and redistribute loading of the wing. Modifications of the airfoil according to embodiments described herein, including installing a trailing edge extender, are easy to implement, do not require span extensions or tip devices, and improve fuel efficiency.

The inventive aspects described herein are applicable to wings of an aircraft and other wing-like devices without limitation. For example, the inventive aspects described herein can be incorporated into embodiments disclosed in U.S. Pat. No. 9,381,999; U.S. Pat. No. 8,944,386; U.S. Pat. No. 9,038,963; U.S. Pat. No. 9,302,766; US 2018/0043985; and WO 2017/176583, each of which is incorporated by reference in its entirety into this application.

### BRIEF DESCRIPTION OF DRAWINGS

FIG. 1 is a graph illustrating an overlay of an original trailing edge and an exemplary embodiment of an improved trailing edge of an airfoil, according to embodiments herein;

FIG. 2 is a graph illustrating the full airfoil of FIG. 1 and includes an overlay of the original trailing edge and the improved trailing edge of FIG. 1;

FIG. 3 is a graph of sectional lift coefficient as a function of span station of a typical transport airfoil and shows sections of span stations that may be improved by incorporating the improved trailing edge of FIGS. 1 and 2;

FIG. 4 is a graph of sectional pressure distribution coefficient as a function of a ratio of chord station to chord length and demonstrates that the airfoil with the improved trailing edge exhibits a weaker shock than the airfoil with the original trailing edge;

FIG. 5 is a graph of sectional lift coefficient as a function of attack angle and illustrates that the airfoil with the improved trailing edge generates a greater lift at a lower angle of attack than does the airfoil with the original trailing edge;

FIG. 6 is a graph of lift coefficient as a function of total drag coefficient at a constant Mach number for both the original airfoil and the improved airfoil, and demonstrates that an improvement in total airfoil drag generally increases as a function of lift coefficient;

FIG. 7 is graph of lift coefficient as a function of airfoil wave-drag coefficient at a constant Mach number for both the original airfoil and the improved airfoil, and shows a reduction in wave-drag for the improved airfoil increases as a function of lift coefficient;

FIG. 8 is a graph of lift coefficient as a function of airfoil induced drag coefficient at a constant Mach number for both the original airfoil and the improved airfoil, and illustrates a decrease in induced drag for the improved airfoil increases as a function of lift coefficient;

FIG. 9 is a graph of total drag coefficient as a function of Mach number at a constant coefficient of lift for both the original airfoil and the improved airfoil, and shows a decrease in total drag for the improved airfoil;

FIG. 10 is a graph of lift coefficient as a function of drag increment percentage at a constant Mach number for the improved airfoil, and illustrates that an improvement in total drag expressed as a percentage as the lift coefficient increases; and

FIG. 11 illustrates a total pressure loss from a leading edge to a trailing edge of a typical transport wing operating at a constant Mach number.

### DETAILED DESCRIPTION

Before some particular embodiments are provided in greater detail, it should be understood that the particular embodiments provided herein do not limit the scope of the concepts provided herein. It should also be understood that a particular embodiment provided herein can have features that can be readily separated from the particular embodiment and optionally combined with or substituted for features of any of a number of other embodiments provided herein.

Regarding terminology used herein, it should also be understood the terminology is for the purpose of describing some particular embodiments, and the terminology does not limit the scope of the concepts provided herein. Unless indicated otherwise, ordinal numbers (e.g., first, second, third, etc.) are used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

In one embodiment, a decrease in total drag of an airfoil is produced by shifting the airfoil trailing edge aft by installing a trailing edge extender along the length of the wing, i.e., from the wing root to the wing tip. For example, a shift aft of about 1.5 inches for an airfoil with an original length of about 74 inches provides a decrease in the total drag of the airfoil, as shown in the figures. In one embodiment, shifting the trailing edge of the airfoil aft in a range from about 1.5 inches to about 3.5 inches has been discovered to decrease the total drag for the airfoil. In one embodiment, the shift distance of the trailing edge is calculated as a function of the local chord length. In one embodiment, shifting the airfoil trailing edge aft a distance in a range from about 2% to about 5% decreases the total drag for the airfoil. The shift distance of the trailing edge of the airfoil may be accompanied by a change in curvature of the trailing edge in some embodiments. In one embodiment, an improved airfoil trailing edge (e.g., shifting the original airfoil trailing edge aft by installing a trailing edge extender, removing a portion of the airfoil trailing edge and re-shaping by installing a trailing edge modifier to change the camber, etc.) results in a decrease of total drag of the airfoil at cruise Mach numbers in a range from about 3% to about 5%. In one embodiment, the improved airfoil trailing edge does not impart any additional loads on the wing structure. In one embodiment, the improved airfoil trailing edge has negligible effects on flying qualities. It is contemplated, therefore, that such an embodiment (e.g., shifting the original airfoil trailing edge aft by installing a trailing edge extender) would require a relatively short time period to receive certification by the Federal Aviation Administration (FAA).

In addition to providing an improved airfoil trailing edge for a wing of an aircraft, in some embodiments, an aileron modification may be made to enhance the decrease in total drag. The aileron(s) of the wing may include a trailing edge extender similar to the improved airfoil trailing edge described herein and/or have a rotation about its hinge of about 0.5 degrees to change the camber of the airfoil that includes the aileron. As will be appreciated, the ailerons enable a pilot to control rolling of an aircraft, and thus the ailerons generally are deployed in a symmetrical fashion on both the left and right wings.

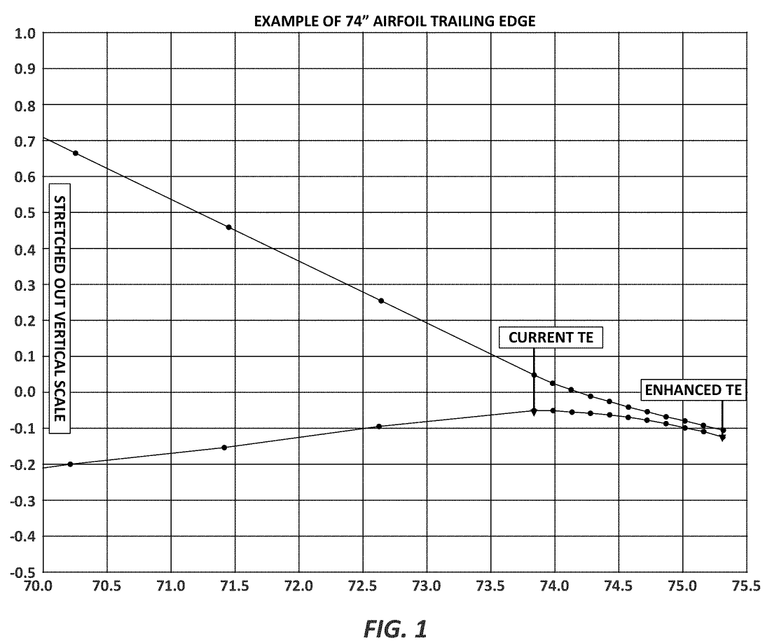

Referring now to FIG. 1, the trailing edge of an airfoil is shown with a length along the x-axis and a stretched height along the y-axis. An airfoil of a typical transport is labeled “Current TE” at the original location of the trailing edge of an airfoil having a length of about 74 inches (shown as approximately 73.8 inches). An inventive extension to the airfoil is labeled as “Enhanced TE” at the end of the inventive extension, which is shown as about 1.5 inches from the original location of the trailing edge. In one embodiment, the extension is provided by installing a trailing edge extender on the wing of the transport aircraft. In addition to a length element, the inventive extension also includes a slight curvature downward. The curvature may be determined as an amount of vertical drop of the TE relative to the original TE. In some embodiments, the degree of curvature may be a function of shock strength acting on the airfoil. In an embodiment, an advantageous TE drop has been found to be about 5 degrees with respect to the original TE angle.

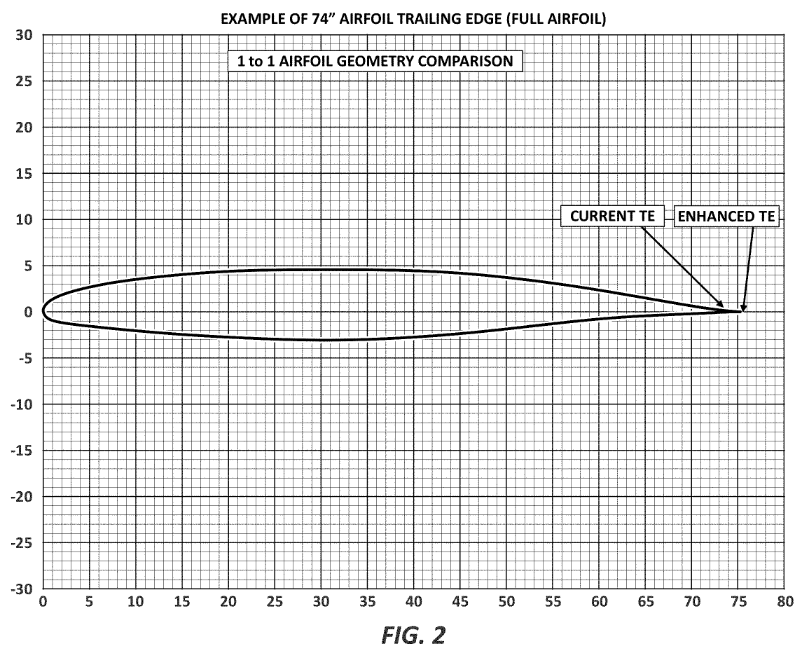

FIG. 2 shows the entire length of the airfoil shown in FIG. 1 without the stretched height along the y-axis so that the shape of the airfoil can be seen. The Current TE and Enhanced TE from FIG. 1 are labeled with the inventive extension indicated.

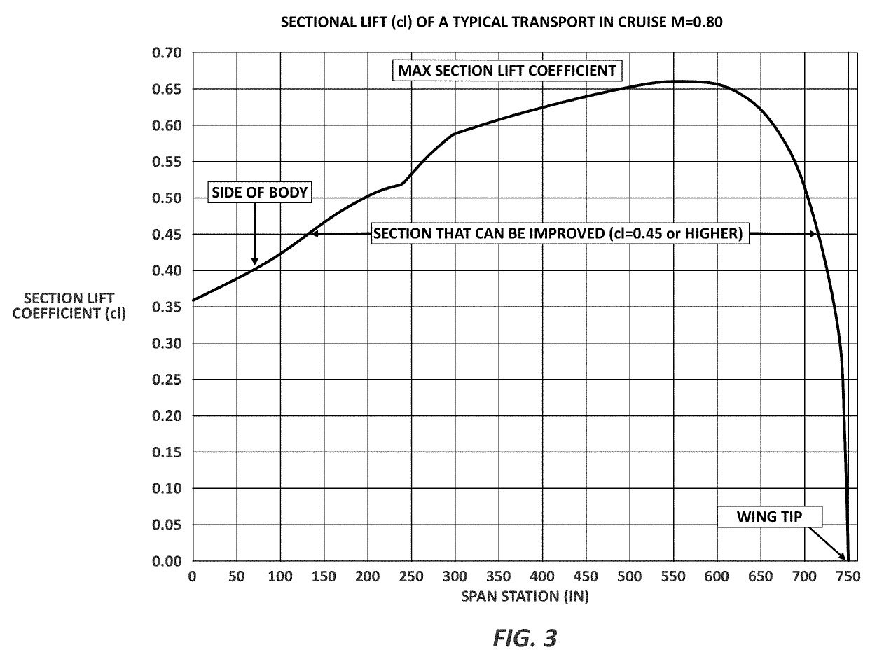

FIG. 3 shows the sectional lift or lift coefficient (CL) of a typical transport at cruise Mach no. 0.80 with the section lift coefficient on the y-axis and the span station on the x-axis. As will be appreciated by those skilled in the art, a wing may be considered to be comprised of many airfoils, distributed from the root to a tip of the wing. The airfoils may be associated with an array of lift coefficients, such as those illustrated in FIG. 3. As shown in FIG. 3, the airfoils with lift coefficients (CL) of 0.45 or greater may be subjected to shocks, and thus may be improved, as described herein.

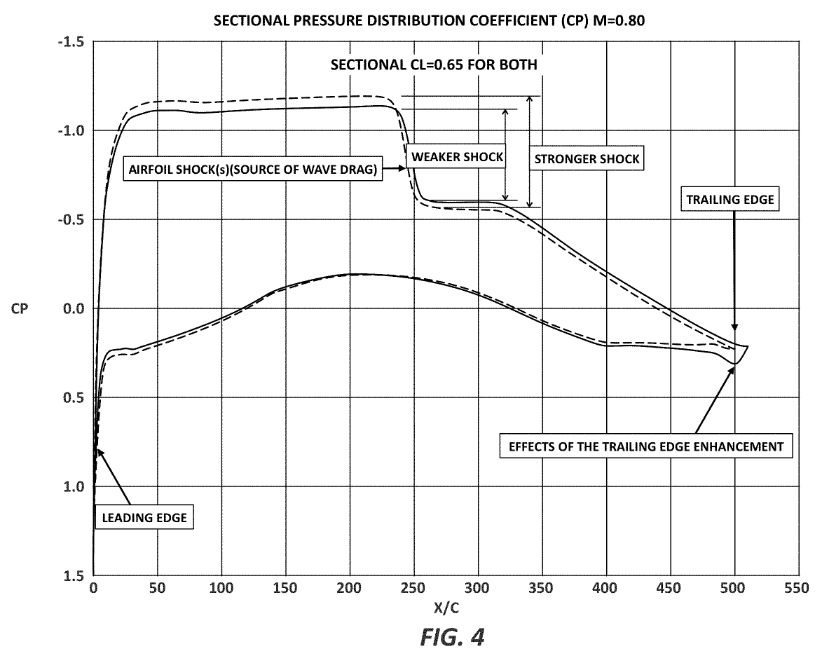

FIG. 4 demonstrates the pressure distribution coefficient (CP) at cruise Mach no. 0.80 for both the original airfoil (dotted line) and the improved airfoil with inventive extension (solid line) of FIGS. 1 and 2. The y-axis represents the pressure distribution coefficient and the x-axis represents a ratio of chord station to chord length, expressed as X/C. At a lift coefficient of 0.65, the difference between the shock acting on each of the airfoils can be seen with the improved airfoil with inventive extension exhibiting a weaker shock than the original airfoil, resulting in a reduced wave drag. Further, as demonstrated by FIG. 4, there has been a re-distribution of loading on the airfoil, without any net increase in the loading, arising due to a small change in the circulation pattern over the entire airfoil.

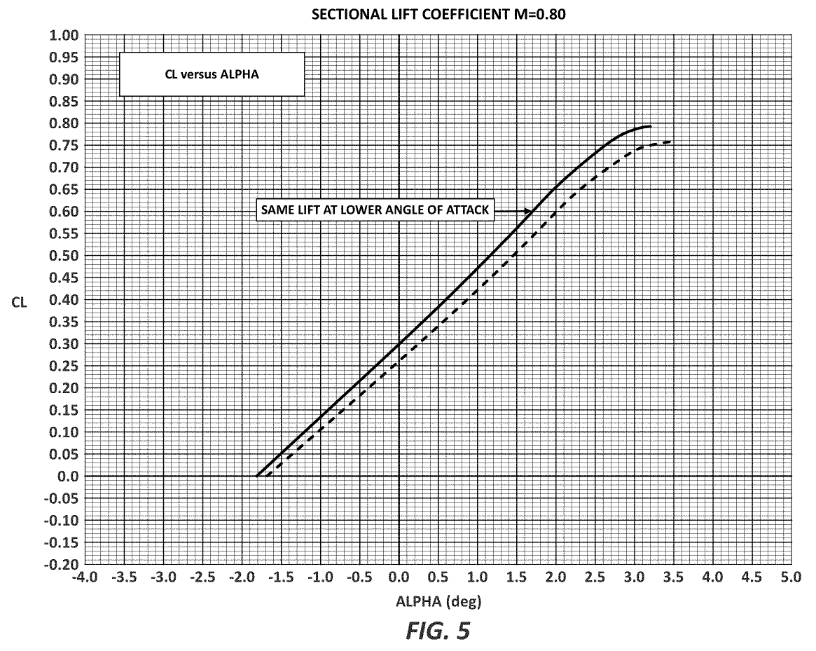

FIG. 5 is a chart illustrating lift coefficient (y-axis) as a function of attack angle (x-axis) for both the original airfoil (dotted line) and the improved airfoil with inventive extension (solid line) of FIGS. 1 and 2. As will be recognized by those skilled in the art, the overall increase in airfoil camber and the above-discussed re-distribution of loading on the airfoil enables the airfoil to generate a greater lift at a lower angle of attack.

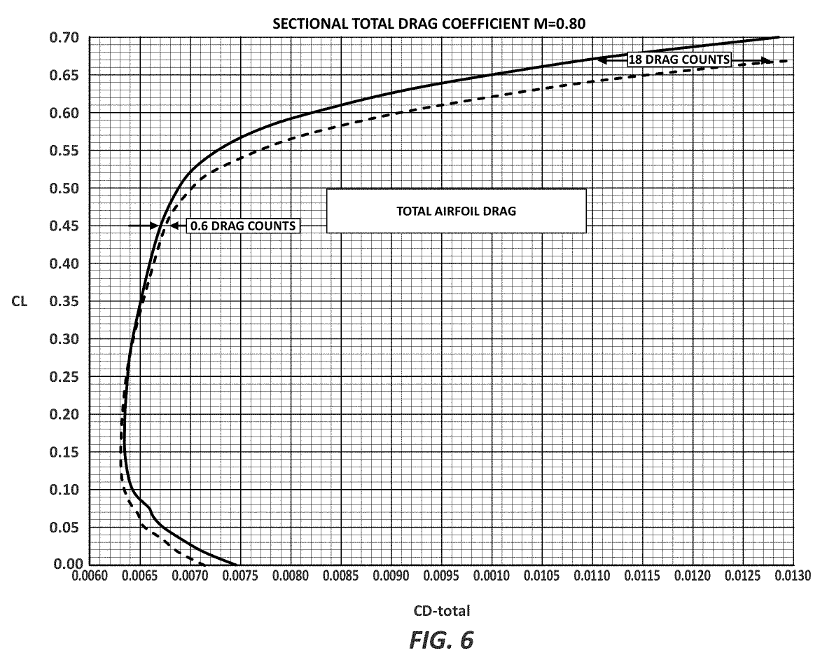

FIG. 6 charts the lift coefficient (y-axis) for change in total drag coefficient (x-axis) at cruise Mach no. 0.80 for both the original airfoil (dotted line) and the improved airfoil with inventive extension (solid line) of FIGS. 1 and 2. This graph demonstrates that an improvement in overall drag generally increases as a function of lift coefficient. Thus, the drag reduction of the improved airfoil becomes more significant with higher the lift coefficient. For example, at CL=0.45, the overall drag for the improved airfoil is decreased by 0.6 drag counts, and at CL=0.67 the overall drag is reduced by about 18 drag counts. As will be recalled from FIG. 3, a CL at or above 0.45 provides an opportunity for improved fuel efficiency by decreasing the overall drag of the airfoil, which is demonstrated in FIG. 6.

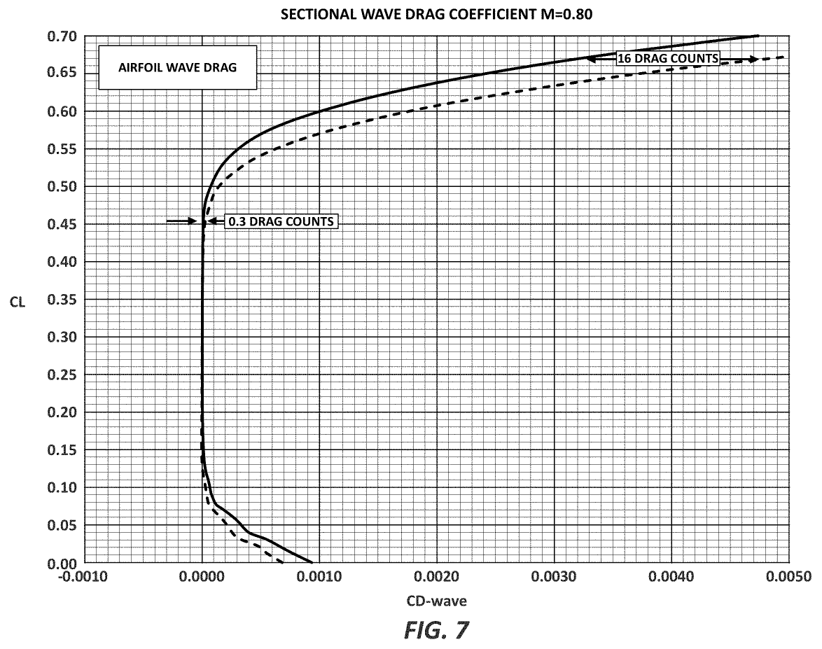

FIG. 7 charts the lift coefficient (y-axis) for change in wave drag coefficient (y-axis) at cruise Mach no. 0.80 for both the original airfoil (dotted line) and the improved airfoil with inventive extension (solid line) of FIGS. 1 and 2. This graph shows the decrease in wave drag for the improved airfoil at CL=0.45 of 0.3 drag counts and at CL=0.67 of 16 drag counts.

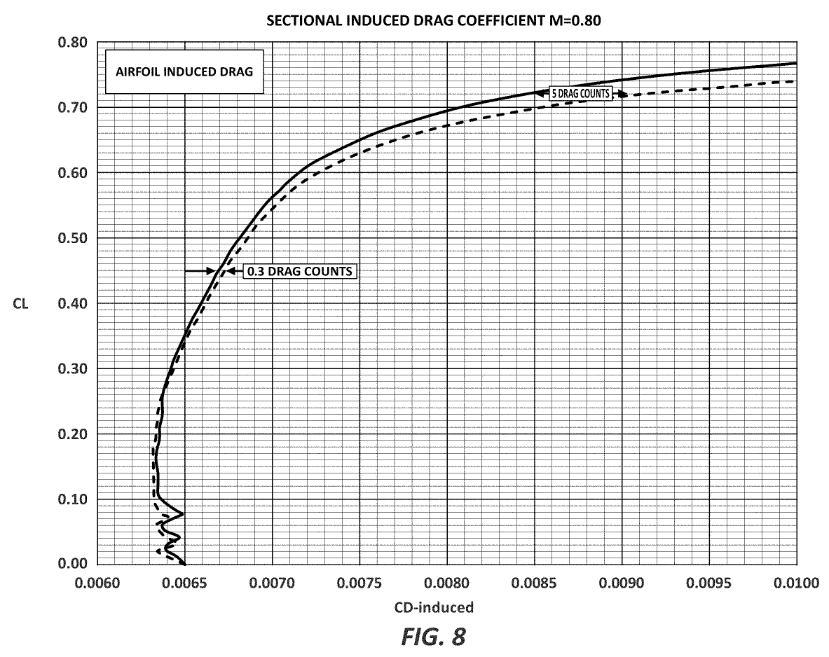

FIG. 8 charts the lift coefficient (y-axis) for change in induced drag coefficient (y-axis) at cruise Mach no. 0.80 for both the original airfoil (dotted line) and the improved airfoil with inventive extension (solid line) of FIGS. 1 and 2. This graph shows the decrease in induced drag for the improved airfoil at CL=0.45 of 0.3 drag counts and at CL=0.67 of 5 drag counts.

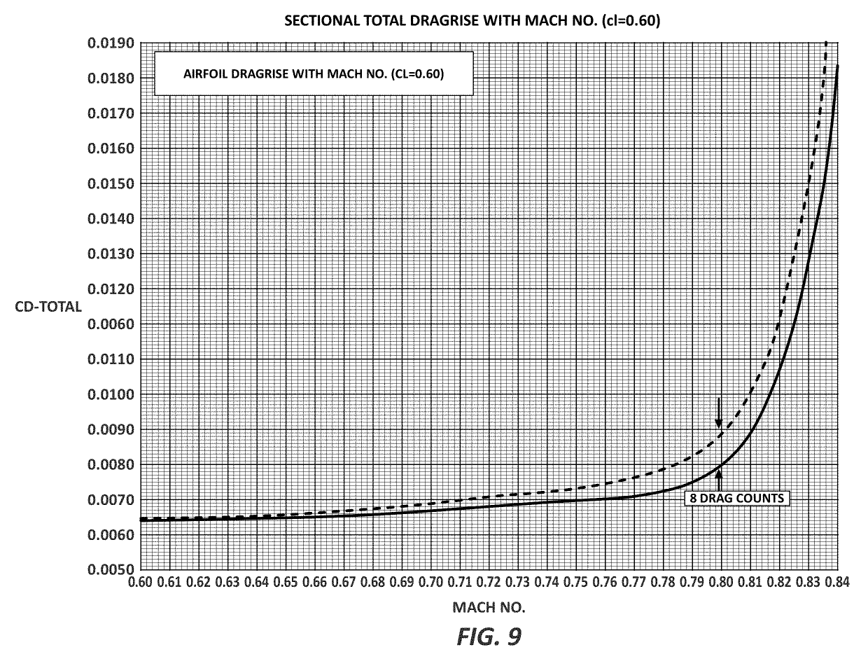

FIG. 9 charts the rise in total drag (y-axis) at lift coefficient of 0.60 as Mach no. (x-axis) increases for both the original airfoil (dotted line) and the improved airfoil with inventive extension (solid line) of FIGS. 1 and 2. At Mach no. 0.80, the decrease in total drag for the improved airfoil is 8 drag counts, which can be verified by comparing the difference in the original airfoil and improved airfoil in FIG. 6.

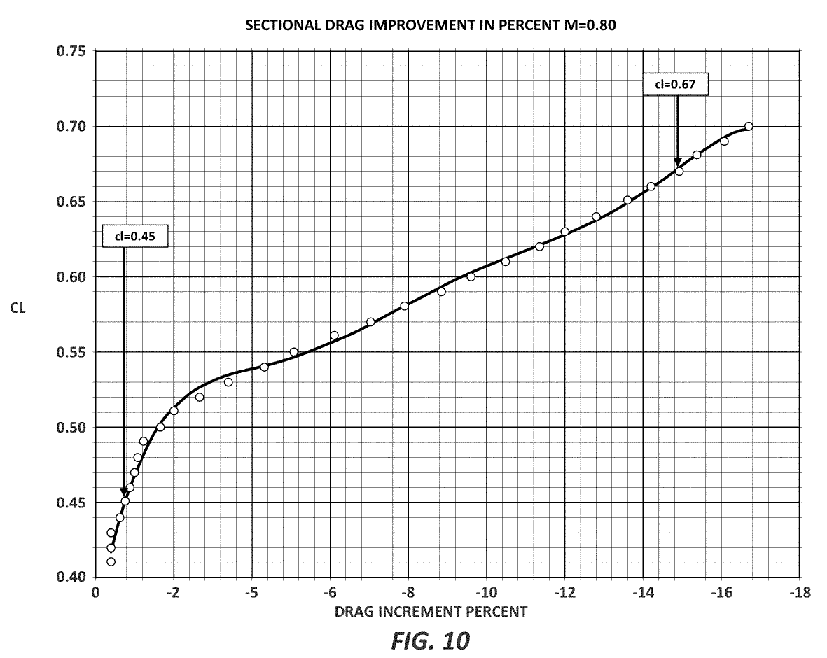

FIG. 10 shows the improvement in total drag expressed as a percentage (x-axis) as the lift coefficient increases. The decrease in total drag percentage from a lift coefficient of 0.45 to 0.67 is pointed out at opposite ends of the curve.

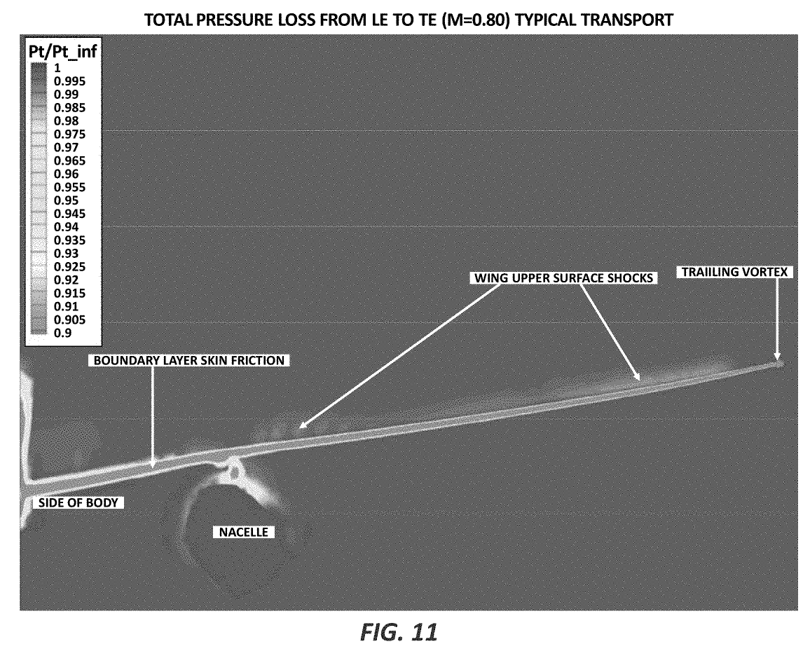

FIG. 11 shows the total pressure loss from a leading edge (LE) to a trailing edge (TE) of a typical transport operating at a cruising Mach no. of 0.80. As will be appreciated, the losses due to increased wave drag is a function of entropy losses when the airflow traverses from the leading edge to the trailing edge. In FIG. 11, these losses are quantified as a total pressure loss (ΔP_{T}) across the airfoil. The red areas represent losses encountered in the boundary layer, and the light blue areas represent losses due to shock fronts. As discussed hereinabove, losses due to these shock fronts are substantially reduced by the inventive extension of the present disclosure.

While some particular embodiments have been provided herein, and while the particular embodiments have been provided in some detail, it is not the intention for the particular embodiments to limit the scope of the concepts presented herein. Additional adaptations and/or modifications can appear to those of ordinary skill in the art, and, in broader aspects, these adaptations and/or modifications are encompassed as well. Accordingly, departures may be made from the particular embodiments provided herein without departing from the scope of the concepts provided herein.

What is claimed is:

1. A method for reducing total drag of a wing airfoil, the airfoil including a leading edge and a trailing edge, comprising:
installing a trailing edge extender to the wing along a length thereof, the trailing edge extender shifting the trailing edge of the airfoil aft.

2. The method according to claim 1, further comprising removing a portion of the wing prior to installing the trailing edge extender.

3. A shock reduction element for an airplane wing having an airfoil, the airfoil including a leading edge and a trailing edge, comprising:
a trailing edge extender designed to shift the trailing edge of the airfoil aft.

4. The shock reduction element according to claim 3, wherein the trailing edge extender is installed on the airplane wing from a wing root to a wing tip.

5. The shock reduction element according to claim 3, wherein the airfoil has an original length from the leading edge to the trailing edge of about 74 inches, and wherein the trailing edge extender has a length in the aft direction in a range from about 1.5 inches to about 3.5 inches.

6. The shock reduction element according to claim 5, wherein the trailing edge extender has a length in the aft direction of about 1.5 inches.

7. The shock reduction element according to claim 3, wherein the trailing edge extender has a length in the aft direction in a range from about 2% to about 5% of an original length of the airfoil from the leading edge to the trailing edge.

8. The shock reduction element according to claim 3, wherein the trailing edge extender includes a curvature.

9. The shock reduction element according to claim 8, wherein the airfoil trailing edge has an original trailing edge angle, and wherein the curvature adds about 5 degrees thereto.

10. The shock reduction element according to claim 8, further comprising one or more ailerons biased in about a 0.5 degree downward rotation about a hinge thereof to accompany the curvature.
